(19) United States
(12) Patent Application Publication
(10) Pub. No.: US 2017/0073575 A1
(43) Pub. Date: Mar. 16, 2017

(54) DENDRITIC POLYMERS FOR USE AS SURFACE MODIFICATION AGENTS

(71) Applicant: HALLIBURTON ENERGY SERVICES, INC., Houston, TX (US)

(72) Inventors: Loan K. Vo, Houston, TX (US); Bradley J. Sparks, Richmond, TX (US); Philip D. Nguyen, Houston, TX (US)

(21) Appl. No.: 15/123,563

(22) PCT Filed: Apr. 7, 2014
(86) PCT No.: PCT/US2014/033122

§ 371 Date: Sep. 2, 2016

(51) Int. Cl. C09K 8/80; E21B 43/04; E21B 43/267; C07F 7/21; C09K 8/56

(52) U.S. Cl. CPC C09K 8/805; C07F 7/21; C09K 8/56; E21B 43/267; E21B 43/04; E21B 43/26

(57) ABSTRACT

Methods and compositions for treating proppant and/or formation sand to enhance proppant pack conductivity, control fines migration, and stabilize formation sand during the well production are provided. In one embodiment, the method comprises: introducing a fines migration control agent into a fluid comprising a base fluid and a plurality of proppants, wherein the fines migration control agent comprises a core group capable of attaching to the proppant and at least one end group connected to the core group capable of capturing fines; mixing the fines migration control agent with the fluid to form a proppant slurry; and injecting the proppant slurry into a wellbore penetrating at least a portion of a subterranean formation.

### BACKGROUND

The present disclosure provides methods and compositions for treating proppant and/or formation sand to enhance proppant pack conductivity, control fines migration, and stabilize formation sand during the well production.

Hydrocarbon-producing wells are often stimulated by hydraulic fracturing treatments. In hydraulic fracturing treatments, a viscous fracturing fluid, which may also function as a carrier fluid, is pumped into a producing zone to be fractured at a rate and pressure such that one or more fractures are formed in the zone. Particulate solids for propping the fractures, commonly referred to in the art as “proppant,” are generally suspended in at least a portion of the fracturing fluid so that the particulate solids are deposited in the fractures when the fracturing fluid reverts to a thin fluid to be returned to the surface. The proppant deposited in the fractures functions to prevent the fractures from fully closing and maintains conductive channels through which produced hydrocarbons can flow.

Additionally, hydrocarbon wells are often located in subterranean zones that contain unconsolidated particulates that may migrate within the subterranean formation with the oil, gas, water, and/or other fluids produced by a well penetrating the subterranean formation. As used herein, the term “unconsolidated particulates,” and derivatives thereof, includes loose particulates and particulates bonded with insufficient bond strength to withstand the forces created by the production of fluids through the formation, which may include but are not limited to formation fines and/or proppant particulates. “Formation fine(s),” another term used herein, refers to any loose particles within the portion of the formation, including, but not limited to, formation fines, formation sand, clay particulates, coal fines, and the like.

Flowback of the proppant, unconsolidated particulate, or formation fines with formation fluids is undesirable as it may erode metal equipment, plug piping and vessels, and cause damage to valves, instruments, and other production equipment. To reduce or prevent the subsequent flowback of proppant and other unconsolidated particulates with the produced fluids, a portion of the proppant introduced into the fractures may be coated with a hardenable resin composition. When the fracturing fluid, which is the carrier fluid for the proppant, reverts to a thin fluid, the resin-coated proppant is deposited in the fracture, and the fracture closes on the proppant. Such partially closed fractures apply pressure on the resin-coated proppant particles, causing the particles to be forced into contact with each other while the resin composition hardens. The hardening of the resin composition under pressure brings about the consolidation of the resin-coated proppant particles into a hard permeable mass having compressive and tensile strength that hopefully prevents unconsolidated proppant and formation sand from flowing out of the fractures with produced fluids.

Even when proppant particles or other large particles are consolidated into a hard permeable mass, the smaller formation fines may still flow back with the production fluid resulting in many of the same problems. The proppant particles may be coated with a surface modification agent which, under certain circumstances, may bind medium-sized proppant particles and, to a lesser extent, the smaller formation fines.

### BRIEF DESCRIPTION OF THE DRAWINGS

These drawings illustrate certain aspects of some of the embodiments of the present disclosure, and should not be used to limit or define the claims.

FIG. 1 illustrates one example of a fines migration control agent according to the teachings of the present disclosure.

FIG. 2 illustrates the chemical structure of one example of a fines migration control agent according to the present disclosure that uses a half polysiloxane cage.

FIG. 3 illustrates an alternative chemical structure of an example of a fines migration control agent according to the present disclosure.

FIG. 4 illustrates the chemical structure of one embodiment of a fines migration control agent according to the present disclosure that uses a full polysiloxane cage.

FIG. 5 illustrates an alternative example of a fines migration control agent according to the teachings of the present disclosure.

FIG. 6 illustrates an example of a system where certain embodiments of the present disclosure may be used.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DESCRIPTION OF EMBODIMENTS

The present disclosure provides methods and compositions for treating proppant and/or formation sand to enhance proppant pack conductivity, control fines migration, and stabilize formation sand during the well production. The present disclosure provides compositions of a new surface modification agent and methods for treating proppant and/or formation sand with this surface modification agent to enhance proppant pack conductivity, control fines migration, and stabilize formation sand during the well production.

The methods of the present disclosure generally involve the use of a dendritic-like fines migration control agent. The fines migration control agent comprises two functional groups that are connected together. The first functional group is a core group that is capable of interacting with the proppant substrate to anchor the fines migration control agent to the surface of the proppant. The second functional group is an end group that is capable of binding and/or capturing fines. In certain embodiments, the fines migration control agent may take the shape of a dendritic wedge.

The core group may be any chemical group that is capable of interacting with the proppant surface to anchor the fines migration control agent. Examples of suitable core groups include, but are not limited to, an acid group including carboxylic acids, a quaternary ammonium, a silanol, or 3,4-dihydroxyphenyl (catechol). In certain embodiments, the core group may have the following formula: —Si(OR)₃ or NR₄⁺. In certain embodiments, the core group may be a polar or hydrophilic functional group to facilitate binding to the proppant surface. In certain embodiments, the core group may anchor the fines migration control agent to the proppant surface.

The end group may be any chemical group that is capable of binding and/or capturing fines. Examples of suitable end groups include, but are not limited to, long alkyl groups and polyacrylamide. In certain embodiments, the alkyl group may include at least eight carbon atoms. In certain embodiments, the end group may be a non-polar or hydrophobic functional group. In certain embodiments, the end group may interact with and capture the formation fines. In this way, the end group may be responsible for the “tackiness” of the fines migration control unit.

The core group and the end group may be connected to each other directly or they may be connected indirectly through an intermediary group. In certain embodiments, the fines migration control agent may have from about 1 to about 10 intermediary groups. Examples of suitable intermediary groups include, but are not limited to, -poly(amidoamine) (PAMAM), poly(propyleneimine) (PPI), aromatic polyethers (Frechet type dendrimers), aliphatic, aromatic, and ether compounds. In certain embodiments, the intermediary group may provide a binding site for both the core group and the end group. Any chemical group capable of providing these binding sites may be suitable provided it does not interfere with the functionality of the core group and the end group. A person of skill in the art with the benefit of this disclosure would be able to select the chemical functionalities to be used as intermediary groups based on the properties desired. The properties include, but are not limited to, solubility, thermal stability, and reactivity towards other chemistries.

The core group and the end groups may work in concert to provide an improved fines migration control agent having two complementary functionalities. As discussed above, the core group attaches to the surface of the proppant or other particulate. This serves to anchor the end groups, which in turn bind and capture the formation fines. In certain embodiments, the fines migration control agent may function like a net that has been anchored to the proppant surface.

The number of end groups in the fines migration control agent may be tailored depending on the desired use or application. The number of end groups may range from about one to about eight. In certain embodiments, the number of end groups may be tailored by adding more chains directly to the core group or to the intermediary group. In other embodiments, the number of end groups may also be tailored by modifying the number of generations. For example, the first set of end groups (i.e., those attached directly to the core group or to the intermediary group) may branch to form additional end groups. In these embodiments, the number of end groups may be increased by increasing the number of branches. It may be beneficial to increase the number of end groups for certain applications. For example, increasing the number of end groups may allow the fines migration control agent to capture additional fines. This can be desirable, for example, in the treatment of a poorly consolidated formation or a formation with a high percentage of formation fines. However, including too many end groups may make the synthesis of the fines migration control agent more difficult or may pose potential problems with steric hindrance. A person of skill in the art with the benefit of this disclosure will be able to determine the appropriate number of end groups for a desired application.

In certain embodiments, the number of core groups in the fines migration control agent may be adjusted to modify the properties of the fines migration control agent. In a preferred embodiment, the fines migration control agent has one core group. However, by increasing the number of core groups, it may be possible to facilitate the binding of the fines migration control agent to the proppant surface. For similar reasons to those discussed above, however, including too many core groups may create difficulties with the synthesis of the fines migration control agent or with steric hindrance. A person of skill in the art with the benefit of this disclosure will be able to determine the appropriate number of core groups for a desired application.

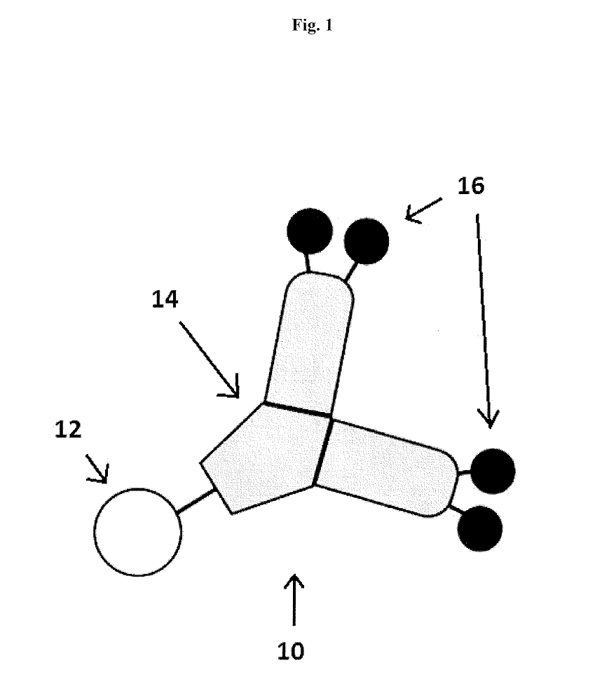

FIG. 1 illustrates one embodiment of a fines migration control agent 10 according to the teachings of the present disclosure. The core group 12 is shown at one end of the fines migration control agent. In this embodiment, core group 12 is a silanol functional group. A plurality of end groups 16 is shown at the other end of the fines migration control agent. In this embodiment, end groups 16 are hydrophobic functional groups, such an as alkyl chain. As shown in the embodiment of FIG. 1, the core group 12 and the end groups 16 are connected via an intermediary group 14. While FIG. 1 illustrates an embodiment of the fines migration control agent with four end groups 16, a person of skill in the art with the benefit of this disclosure will recognize that a different number may be appropriate.

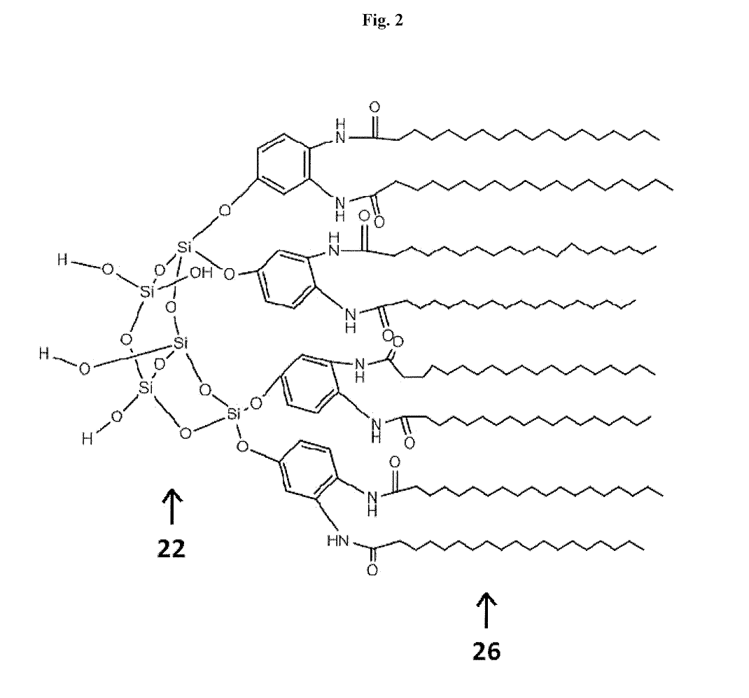

FIG. 2 illustrates the chemical structure of one embodiment of a fines migration control agent according to the present disclosure that takes advantage of POSS chemistry to construct a wedge-like dendritic fines migration control agent. “POSS” refers to polyhedral oligomeric silsesquioxanes, a cage-like organosilicon compound. As shown in FIG. 2, a half polysiloxane cage 22 is used as the core group to build the fines migration control agent. A plurality of end groups 26 are attached to the half polysiloxane cage 22. The end groups 26 include long alkyl chains that may range from about six carbon atoms to about eighteen carbon atoms. The polar groups in the polysiloxane core are responsible for anchoring the wedge-like molecule onto the proppant or formation sand surface. The hydrophobic branches of the wedge are responsible for catching or binding fines.

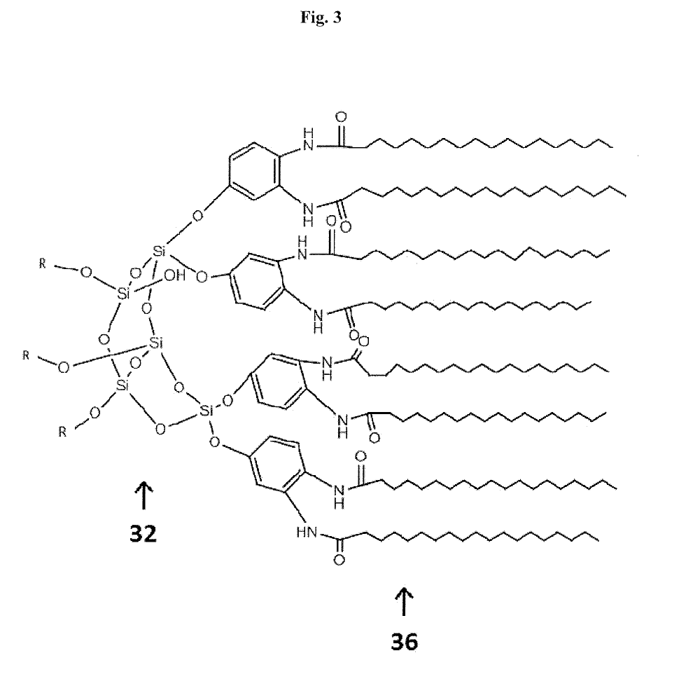

FIG. 3 illustrates an alternative chemical structure of an embodiment of the fines migration control agent according to the present disclosure. FIG. 3 is similar to FIG. 2 except that it has additional functional groups attached to the polysiloxane cage 32. In certain embodiments, R may be a methyl or ethyl group. The embodiment in FIG. 3 has similar end groups 36. As described in connection with FIG. 2, the functional groups in the polysiloxane cage are responsible for anchoring the molecule onto the proppant or formation surface, which the hydrophobic branches are responsible for catching or binding fines.

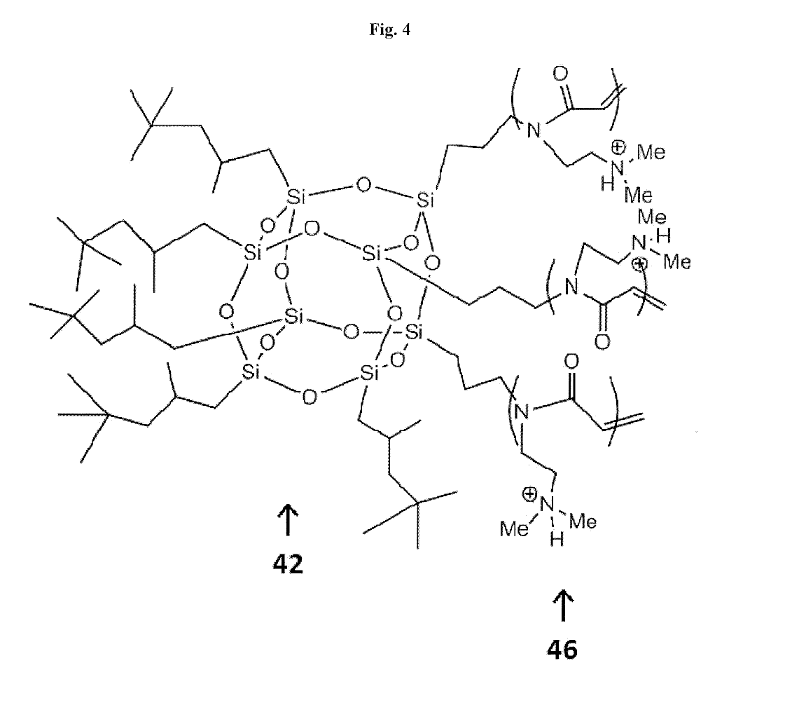

FIG. 4 illustrates the chemical structure of one embodiment of a fines migration control agent according to the present disclosure. In particular, FIG. 4 shows an embodiment where a full polysiloxane cage is used as the core to build a dendritic polymer with functionalized polyacrylamide. The hydrophobicity of the alkyl functionalized siloxane 42, shown on the left of FIG. 4, is responsible for catching the fines. The cationic ammonium groups 46, shown on the right of FIG. 4, allows anchoring the fines migration control agent to anchor to the proppant or formation sand surface.

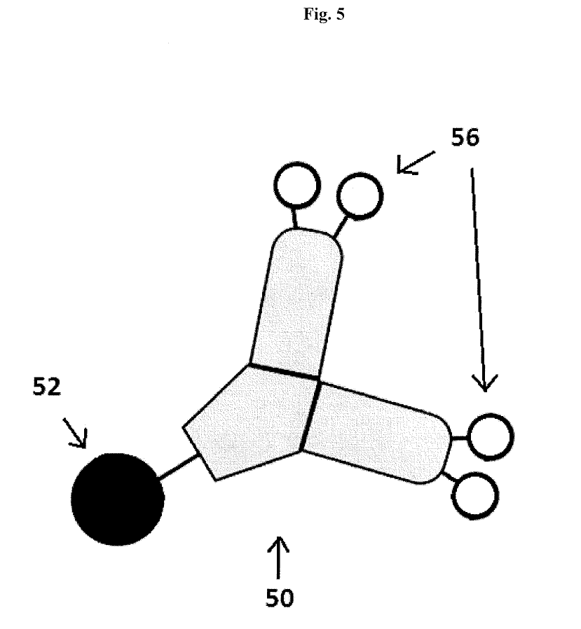

In certain embodiments, the function of the core group and the end groups may be reversed. FIG. 5 illustrates an alternative embodiment of a fines migration control agent 50. The embodiment of FIG. 5 is similar to the embodiment of FIG. 1 except that the hydrophobicity (and associated function) of the core group and the end group is reversed. In particular, core group 52 is a hydrophobic functional group, such as full cage polysiloxane. The end group 56 is a cationic functional group, such as ammonium. In this embodiment, the end groups are responsible for binding onto the proppant or sand surface while the core group provides the polymer with fines catching capability. FIG. 5 demonstrates the flexibility of the teachings of the present disclosure. The specific design may be tailored depending on the particular application to provide a fines migration control agent that has a domain that is capable binding to the surface of the proppant and a domain that is capable of catching fines.

The fines migration control agents described in the present disclosure can be used in a variety of processes to treat a subterranean formation. In one embodiment, the fines migration control agent may be added to a carrier fluid containing proppant particulates. In another embodiment, the fines migration control agent may be dry-coated onto the proppant particulate directly. In yet another embodiment, the fines migration control agent may be used in a remedial treatment fluid. In each of these embodiments, the fines migration control agent may be introduced into the subterranean formation through the wellbore.

In one example, the fines migration control agent may be measured and added to a carrier fluid. The carrier fluid may be an aqueous-based carrier fluid. In certain embodiments, the carrier fluid is a fracturing fluid that contains polymers that will dissolve or hydrate in water and generate a viscous solution. The carrier fluid may contain a proppant particulate in an amount of about 0.1 to about 14 lb/gal. The fines migration control agent may be coated onto the proppant particulate to form a homogenous proppant slurry. The proppant slurry may be injected into the subterranean wellbore as part of a treatment process. Suitable treatment processes include, but are not limited to, hydraulic fracturing, frac packing, and gravel packing treatments.

In other example, the fines migration control agent may be added directly to the proppant particulates. In certain embodiments, the fines migration control agent may be added to the proppant particulates in an amount of about 0.1 to about 10 weight percent. In preferred embodiments, the fines migration control agent may be added to the proppant particulates in an amount of about 0.5 to about 5 weight percent. The coated particulates may be added to a carrier fluid, such as an aqueous-based carrier fluid. In certain embodiments, the coated particulates may be added to the carrier fluid in an amount of about 0.01 to about 30 lb/gal. In preferred embodiments, the coated particulates may be added to the carrier fluid in an amount of about 0.1 to about 14 lb/gal. The proppant particulates may be added to the carrier fluid while it is being mixed or prior to the mixing. The resulting proppant slurry may be injected into the subterranean wellbore.

The fines migration control agent may also be used for remedial purposes. In one example, the fines control agent may be injected into the formation via a carrier fluid (solvent based or aqueous base) to help anchor formation fines in place.

For example, the fines migration control agent may be diluted with a solvent to form a remedial treatment fluid. Suitable solvents include, but are not limited, to isopropanol, dipropylene glycol monomethyl ether, ethylene glycol, monomethyl ether, methanol, aliphatic-based solvents, and diesel. In certain embodiments, the fines migration control agent is added to the solvent in an amount of about 0.1 to about 50 percent volume by volume. In certain embodiments, the treatment fluid has a viscosity of about 1 to about 30 cP. In preferred embodiments, the treatment fluid has a viscosity of about 1 to about 10 cP. The treatment fluid may be injected into the wellbore region near a propped fracture to treat the formation sand matrix or the proppant pack. Finally, a fluid (such as an aqueous-based fluid) may be injected as a post-flush fluid to displace the treatment fluid from the wellbore and to force excess treatment fluid occupying the pore space further out into the formation.

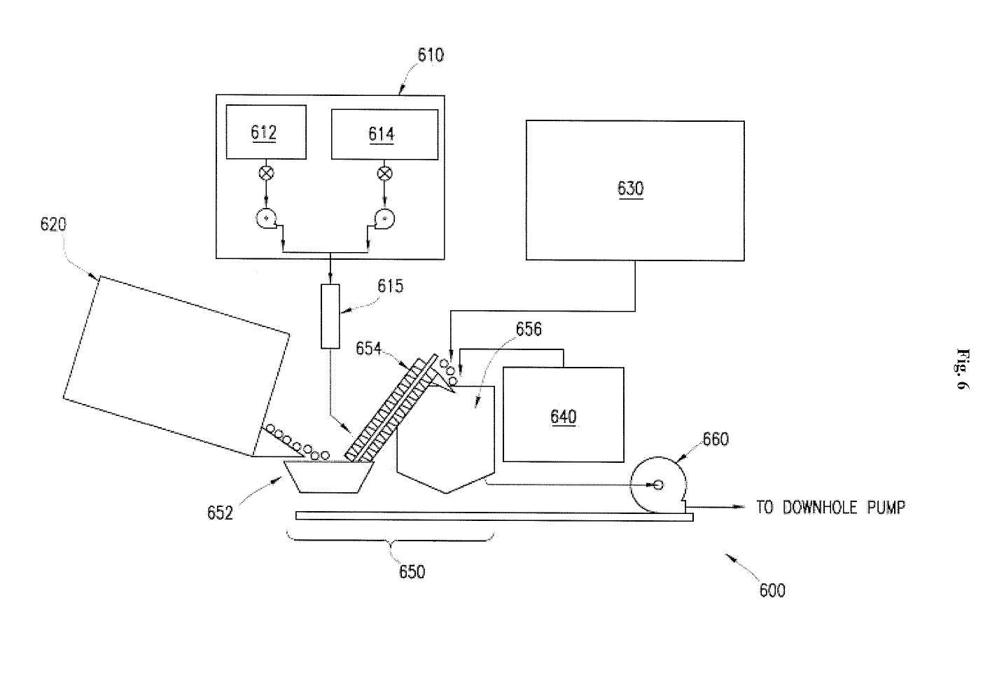

The exemplary chemicals disclosed herein may directly or indirectly affect one or more components or pieces of equipment associated with the preparation, delivery, recapture, recycling, reuse, and/or disposal of the disclosed chemicals. For example, and with reference to FIG. 6, the disclosed chemicals may directly or indirectly affect one or more components or pieces of equipment associated with an exemplary mixing assembly 600, according to one or more embodiments. As one skilled in the art would recognize, the mixing assembly 600 may be used with land-based or sea-based operations.

The mixing assembly 600 may be used to perform an on-the-fly resin coating process during a hydraulic fracturing treatment. As illustrated, the mixing assembly 600 may include a liquid resin skid 610, a sand transport 620, a liquid gel 630, a fracturing additive 640, a fracturing blender 650 and a booster pump 660. In particular, resin from the liquid resin skid 610, sand or other proppant particulates from the sand transport 620, the liquid gel 630, and the fracturing additive 640 are combined in the fracturing blender 650 to form a proppant slurry. The booster pump 660 pumps the slurry to the wellbore where it is pumped downhole with high pressure pump(s).

The liquid resin skid 610 may include a liquid resin 612 and a hardener 614. Types of suitable resins include, but are not limited to, two component epoxy based resins, novolak resins, polyepoxide resins, phenol-aldehyde resins, urea-aldehyde resins, urethane resins, phenolic resins, furan resins, furan/furfuryl alcohol resins, phenolic/latex resins, phenol formaldehyde resins, polyester resins and hybrids and copolymers thereof, polyurethane resins and hybrids and copolymers thereof, acrylate resins, and mixtures thereof. The liquid resin 612 and hardener 614 are combined by the static mixer 615 to form a homogeneous mixture before they are introduced into the fracturing blender 650.

The fracturing blender 650 may include a sand hopper 652, a sand screw 654, and a blender tub 656. Sand or other proppant particulates may be transferred from the sand transport 620 to the sand hopper 652. From there, the sand screw 654 may transfer the sand or other proppant particulates to the blender tub 656. In the blender tub 656, the sand or other proppant particulates may be mixed with the resin and other components to form a resin-coated particulate slurry that is ready to be pumped downhole.

In certain embodiments, the fines migration control agents of the present disclosure may be added directly to the blender tub 652 to form the proppant slurry. In other embodiments, the fines migration control agents may be dry-coated onto the proppant particulates before the proppant particulates are added to the blender tub 652.

An embodiment of the present disclosure is a method comprising: introducing a fines migration control agent into a fluid comprising a base fluid and a plurality of proppants, wherein the fines migration control agent comprises a core group capable of attaching to the proppant and at least one end group connected to the core group capable of capturing fines; mixing the fines migration control agent with the fluid to form a proppant slurry; and injecting the proppant slurry into a wellbore penetrating at least a portion of a subterranean formation. Optionally, the core group comprises a polysiloxane cage. Optionally, the core group comprises a compound selected from the group consisting of: a carboxylic acid; a quaternary ammonium; a silanol; 3,4-dihydroxyphenyl; and any combination thereof. Optionally, the fines migration control agent further comprises an intermediary group, and the core group and the end group are connected indirectly through the intermediary group. Optionally, the fines migration control agent comprises one or more additional end groups. Optionally, the fines migration control agent is mixed with the fluid in a blender tub. Optionally, the proppant slurry is injected in the subterranean wellbore as part of a hydraulic fracturing, frac-packing, or gravel packing treatment.

Another embodiment of the present disclosure is a method comprising: dry-coating a fines migration control agent onto a proppant to form a coated proppant, wherein wherein the fines migration control agent comprises a core group capable of attaching to the proppant and at least one end group connected to the core group capable of capturing fines; mixing the coated proppant with a fluid to form a proppant slurry; and injecting the proppant slurry into a wellbore penetrating at least a portion of a subterranean formation. Optionally, the core group comprises a polysiloxane cage. Optionally, the core group comprises a compound selected from the group consisting of: a carboxylic acid; a quaternary ammonium; a silanol; 3,4-dihydroxyphenyl; and any combination thereof. Optionally, the fines migration control agent further comprises an intermediary group, and the core group and the end group are connected indirectly through the intermediary group. Optionally, the fines migration control agent comprises one or more additional end groups. Optionally, the coated proppant is mixed with the fluid in a blender tub. Optionally, the proppant slurry is injected in the wellbore as part of a hydraulic fracturing, frac-packing, or gravel packing treatment. Another embodiment of the present disclosure is a method comprising: diluting a fines migration control agent with a solvent to form a treatment fluid, wherein the fines migration control agent comprises a core group capable of attaching to a proppant and at least one end group connected to the core group capable of capturing fines; introducing the treatment fluid into a wellbore near a propped fracture in at least a portion of a subterranean formation; and injecting a post-flush fluid to displace the treatment fluid from the wellbore. Optionally, the core group comprises a polysiloxane cage. Optionally, the core group comprises a compound selected from the group consisting of: a carboxylic acid; a quaternary ammonium; a silanol; 3,4-dihydroxyphenyl; and any combination thereof. Optionally, the fines migration control agent further comprises an intermediary group, and the core group and the end group are connected indirectly through the intermediary group. Optionally, the viscosity of the treatment fluid is from about 1 cP to about 30 cP. Optionally, the solvent comprises at least one solvent selected from the group consisting of: isopropanol; dipropylene glycol monomethyl ether; ethylene glycol; monomethyl ether; methanol; aliphatic-based solvents; diesel; and any combination thereof.

Another embodiment of the present disclosure is a composition comprising: a core group capable of attaching to a proppant, and at least one end group connected to the core group capable of capturing fines. Optionally, the core group comprises a polysiloxane cage. Optionally, the core group comprises a compound selected from the group consisting of: a carboxylic acid; a quaternary ammonium; a silanol; 3,4-dihydroxyphenyl; and any combination thereof. Optionally, the composition further comprises an intermediary group, and the core group and the end group are connected indirectly through the intermediary group. Optionally, the end group comprises an alkyl chain having between about 6 to about 18 carbon atoms. Optionally, the composition further comprises one or more additional end groups.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A method comprising:
introducing a fines migration control agent into a fluid comprising a base fluid and a plurality of proppants,
wherein the fines migration control agent comprises a core group capable of attaching to the proppant and at least one end group connected to the core group capable of capturing fines;
mixing the fines migration control agent with the fluid to form a proppant slurry; and
injecting the proppant slurry into a wellbore penetrating at least a portion of a subterranean formation.

2. The method of claim 1 wherein the core group comprises a polysiloxane cage.

3. The method of claim 1 wherein the core group comprises a compound selected from the group consisting of: a carboxylic acid; a quaternary ammonium; a silanol; 3,4-dihydroxyphenyl; and any combination thereof.

4. The method of claim 1 wherein the fines migration control agent further comprises an intermediary group and wherein the core group and the end group are connected indirectly through the intermediary group.

5. The method of claim 1 wherein the fines migration control agent comprises one or more additional end groups.

6. The method of claim 1 wherein the fines migration control agent is mixed with the fluid in a blender tub.

7. The method of claim 1 wherein the proppant slurry is injected in the subterranean wellbore as part of a hydraulic fracturing, frac-packing, or gravel packing treatment.

8. A method comprising:
dry-coating a fines migration control agent onto a proppant to form a coated proppant,
wherein the fines migration control agent comprises a core group capable of attaching to the proppant and at least one end group connected to the core group capable of capturing fines;
mixing the coated proppant with a fluid to form a proppant slurry; and
injecting the proppant slurry into a wellbore penetrating at least a portion of a subterranean formation.

9. The method of claim 8 wherein the core group comprises a polysiloxane cage.

10. The method of claim 8 wherein the core group comprises a compound selected from the group consisting of: a carboxylic acid; a quaternary ammonium; a silanol; 3,4-dihydroxyphenyl; and any combination thereof.

11. The method of claim 8 wherein the fines migration control agent further comprises an intermediary group and wherein the core group and the end group are connected indirectly through the intermediary group.

12. The method of claim 8 wherein the fines migration control agent comprises one or more additional end groups.

13. The method of claim 8 wherein the coated proppant is mixed with the fluid in a blender tub.

14. The method of claim 8 wherein the proppant slurry is injected in the wellbore as part of a hydraulic fracturing, frac-packing, or gravel packing treatment.

15. A method comprising:
diluting a fines migration control agent with a solvent to form a treatment fluid,
wherein the fines migration control agent comprises a core group capable of attaching to a proppant and at least one end group connected to the core group capable of capturing fines;
introducing the treatment fluid into a wellbore near a propped fracture in at least a portion of a subterranean formation; and
injecting a post-flush fluid to displace the treatment fluid from the wellbore.

16. The method of claim 15 wherein the core group comprises a polysiloxane cage.

17. The method of claim 15 wherein the core group comprises a compound selected from the group consisting of: a carboxylic acid; a quaternary ammonium; a silanol; 3,4-dihydroxyphenyl; and any combination thereof.

18. The method of claim 15 wherein the fines migration control agent further comprises an intermediary group and wherein the core group and the end group are connected indirectly through the intermediary group.

19. The method of claim 15 wherein the viscosity of the treatment fluid is from about 1 cP to about 30 cP.

20. The method of claim 15 wherein the solvent comprises at least one solvent selected from the group consisting of: isopropanol; dipropylene glycol monomethyl ether; ethylene glycol; monomethyl ether; methanol; aliphatic-based solvents; diesel; and any combination thereof.

21. A composition comprising:
a core group capable of attaching to a proppant, and
at least one end group connected to the core group capable of capturing fines.

22. The composition of claim 21 wherein the core group comprises a polysiloxane cage.

23. The composition of claim 21 wherein the core group comprises a compound selected from the group consisting of: a carboxylic acid; a quaternary ammonium; a silanol; 3,4-dihydroxyphenyl; and any combination thereof.

24. The composition of claim 21 further comprises an intermediary group and wherein the core group and the end group are connected indirectly through the intermediary group.

25. The composition of claim 21 wherein the end group comprises an alkyl chain having between about 6 to about 18 carbon atoms.

26. The composition of claim 21 further comprising one or more additional end groups.
